(19) United States
(12) Patent Application Publication
(10) Pub. No.: US 2025/0222917 A1
(43) Pub. Date: Jul. 10, 2025

(54) SYSTEM AND METHOD OF TOWING CONTROLS FOR CREATING A HYBRID VEHICLE FROM AN ELECTRIC VEHICLE AND A CONVENTIONAL VEHICLE

(71) Applicant: GM Global Technology Operations LLC, Detroit, MI (US)

(72) Inventors: Todd P. Lindemann, Brighton, MI (US); Richard B. Weinberg, Highland, MI (US); Ruixing Long, Novi, MI (US); Robert Stacey, Swartz Creek, MI (US); Ning Jin, Novi, MI (US); Travis Whitley, Archer, FL (US); Stuart Walter Parker, Ann Arbor, MI (US); Brendan Michael Carr, Howell, MI (US)

(21) Appl. No.: 18/406,590

(22) Filed: Jan. 8, 2024

(51) Int. Cl. B60W 20/13

(52) U.S. Cl. CPC B60W 20/13; B60W 2300/14; B60W 2510/244; B60W 2520/105

(57) ABSTRACT

A serial hybrid vehicle is disclosed. The serial hybrid vehicle includes a first vehicle having a first drive system, a second vehicle having a second drive system and a tow hitch for mechanically coupling the second vehicle to the first vehicle for towing by the first vehicle. A communication path is established between the second vehicle and the first vehicle. A processor at the second vehicle receives a signal transmitted from the first vehicle to a communication device of the second vehicle via the communication path, determines an instruction for operating the second vehicle from the signal, and operates the second drive system along with the first drive system based on the instruction to operate the first vehicle and the second vehicle as the serial hybrid vehicle.

### INTRODUCTION

The subject disclosure relates to operating an electric vehicle being towed by a lead vehicle and, in particular, operating the electric vehicle in synchrony with the lead vehicle during towing.

A vehicle that is towed by another vehicle exerts a drag on the other vehicle that can wear on the operation of the other vehicle. Accordingly, it is desirable to provide a method by which a vehicle being towed can operate along with the towing vehicle to aid in operation of the vehicles as a unit.

### SUMMARY

In one exemplary embodiment, a method of towing a second vehicle by a first vehicle is disclosed. A communication path is established between the second vehicle and the first vehicle, the first vehicle having a first drive system. A signal is transmitted over the communication path from the first vehicle to the second vehicle indicative of an instruction for operating of the second vehicle. The second drive system of the second vehicle is operated along with the first drive system of the first vehicle based on the instruction to operate the first vehicle and the second vehicle as a serial hybrid vehicle.

In addition to one or more of the features described herein, the method further includes selecting a charging mode for charging a battery pack of the second vehicle.

In addition to one or more of the features described herein, the charging mode is one of a rapid charging mode, a hybrid charging mode that maintains a target minimum level, a hybrid max mode that prioritizes propulsion until a state of charge of the battery pack falls to the target minimum level, and a standard charging mode that charges only when allowed.

In addition to one or more of the features described herein, the method further includes at least one of applying a braking at the second vehicle when braking is applied at the first vehicle and applying a torque at the second vehicle in response to an acceleration request from the first vehicle.

In addition to one or more of the features described herein, the method further includes operating the first vehicle and the second vehicle as the serial hybrid vehicle when a speed of the second vehicle is greater than a speed threshold.

In addition to one or more of the features described herein, the method further includes using data from the second vehicle to determine a velocity of the first vehicle when the velocity of the first vehicle is not available to the second vehicle.

In addition to one or more of the features described herein, the method further includes determining a hitch force between the first vehicle and the second vehicle.

In another exemplary embodiment, an electric vehicle is disclosed. The electric vehicle includes an electric drive system, a communication device for communicating along a communication path between the electric vehicle and a first vehicle, the first vehicle having a first drive system, the first vehicle coupled to the electric vehicle for towing the electric vehicle, and a processor. The processor is configured to receive a signal transmitted from the first vehicle to the communication device, determine an instruction for operating the electric vehicle from the signal, and operate the electric drive system of the electric vehicle along with the first drive system of the first vehicle based on the instruction to operate the first vehicle and the electric vehicle as a serial hybrid vehicle.

In addition to one or more of the features described herein, the processor is further configured to select a charging mode for charging a battery pack of the electric vehicle.

In addition to one or more of the features described herein, the charging mode is one of a rapid charging mode, a hybrid charging mode that maintains a target minimum level, a hybrid max mode that prioritizes propulsion until a state of charge of the battery pack falls to the target minimum level, and a standard charging mode that charges only when allowed.

In addition to one or more of the features described herein, the processor is further configured to perform at least one of applying a braking at the electric vehicle when braking is applied at the first vehicle and applying a torque at the electric vehicle in response to an acceleration request from the first vehicle.

In addition to one or more of the features described herein, the processor is further configured to operate the first vehicle and the electric vehicle as the serial hybrid vehicle when a speed of the electric vehicle is greater than a speed threshold.

In addition to one or more of the features described herein, the processor is further configured to use data from the electric vehicle to determine a velocity of the first vehicle when the velocity of the first vehicle is not available to the electric vehicle.

In addition to one or more of the features described herein, the processor is further configured to determine a hitch force between the first vehicle and the electric vehicle.

In yet another exemplary embodiment, a serial hybrid vehicle is disclosed. The serial hybrid vehicle includes a first vehicle having a first drive system, a second vehicle having a second drive system, a tow hitch for mechanically coupling the second vehicle to the first vehicle for towing by the first vehicle, a communication path between the first vehicle and the second vehicle, and a processor at the second vehicle. The processor is configured to receive a signal transmitted from the first vehicle to a communication device of the second vehicle via the communication path, determine an instruction for operating the second vehicle from the signal, and operate the second drive system along with the first drive system based on the instruction to operate the first vehicle and the second vehicle as the serial hybrid vehicle.

In addition to one or more of the features described herein, the processor is further configured to select a charging mode for charging a battery pack of the second vehicle.

In addition to one or more of the features described herein, the processor is further configured to perform at least one of applying a braking at the second vehicle when braking is applied at the first vehicle and applying a torque at the second vehicle in response to an acceleration request from the first vehicle.

In addition to one or more of the features described herein, the processor is further configured to operate the first vehicle and the second vehicle as the serial hybrid vehicle when a speed of the second vehicle is greater than a speed threshold.

In addition to one or more of the features described herein, the processor is further configured to use data from the second vehicle to determine a velocity of the first vehicle when the velocity of the first vehicle is not available to the second vehicle.

In addition to one or more of the features described herein, the processor is further configured to determine a hitch force between the first vehicle and the second vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle 10 in accordance with an exemplary embodiment;

FIG. 2 shows a serial hybrid vehicle, in an illustrative embodiment;

FIG. 3 shows detailed view of a trailer pigtail of the serial hybrid vehicle, in an illustrative embodiment;

FIG. 4 is a diagram illustrating data flowing to the follow vehicle during operation of the serial hybrid vehicle, in an illustrative embodiment;

FIG. 5 is a diagram showing various modules or programs operating the follow vehicle during operation of the serial hybrid vehicle, in an illustrative embodiment;

FIG. 6 shows a flowchart of a method for operating the serial hybrid vehicle, in an illustrative embodiment;

FIG. 7 shows a block diagram illustrating operation of the rapid charging mode;

FIG. 8 is a block diagram illustrating operation of a feedforward algorithm for determining a desired regeneration torque at the second vehicle, in an illustrative embodiment;

FIG. 9 is a block diagram illustrating operation of a feedforward operation algorithm at the second vehicle in an alternative embodiment in which a force applied by the second vehicle to the first vehicle is not directly measurable; and

FIG. 10 shows a serial hybrid vehicle in another illustrative embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

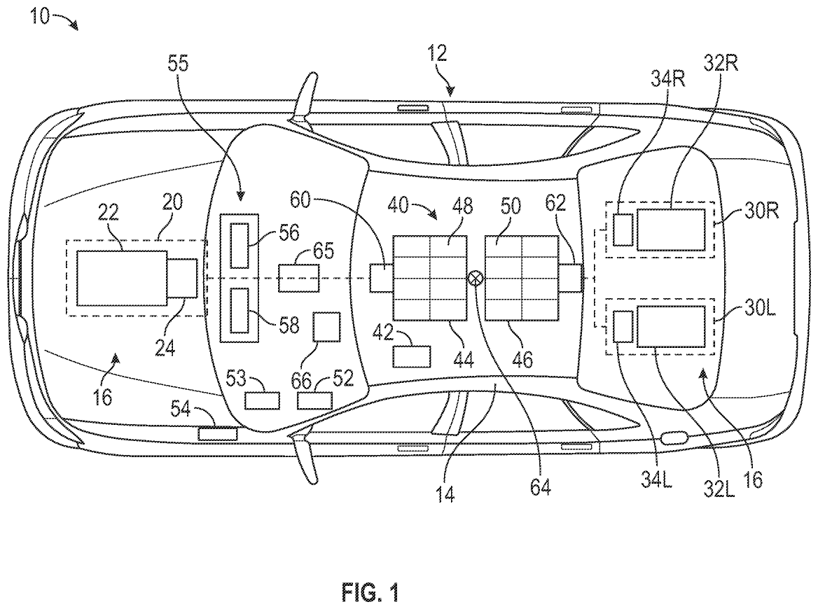

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent. In another embodiment, the vehicle can include a single motor that drivers the wheels through a conventional driveline.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to a battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a plurality of battery modules 48, and the second battery pack 46 includes a plurality of battery modules 50. Each battery module 48, 50 includes a number of individual cells (not shown). In various embodiments, one or more of the battery packs can include a MODACS (Multiple Output Dynamically Adjustable Capacity) battery.

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). For V2X charging, power can be exported to an external load, a home (working as backup power to the home) or to a utility grid, for example. The charging system includes one or more charging modules. For example, a first onboard charging module (OBCM) 52 is electrically connected to a charge port 54 for charging to and from an DC system or device offboard of the vehicle 10 (e.g., DC fast charging or DCFC), such as a utility DC power supply. DCFC can be accomplished through the charge port 54 and switching devices controlled by the battery control module (e.g., first OBCM 52) and/or an additional module 66 specific to DCFC communication signals. A second onboard charging module (OBCM) 53 may be included for AC onboard charging, including high power AC charging or V2X charging.

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle, a hybrid vehicle, etc.

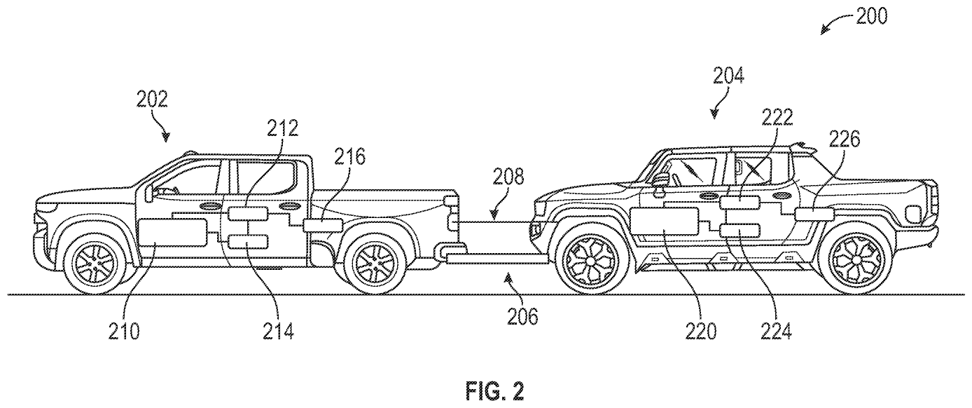

FIG. 2 shows a serial hybrid vehicle 200, in an illustrative embodiment. The serial hybrid vehicle 200 includes a first vehicle 202 (lead vehicle) and a second vehicle 204 (follow vehicle) that are mechanically coupled, generally for towing, and which operate synchronously as a single power entity. The first vehicle 202 can be any type of vehicle, such as a gas-powered vehicle, diesel-powered vehicle, an electric vehicle, a hybrid vehicle, etc. The second vehicle 204 is an electric vehicle, such as shown in FIG. 1. The first vehicle 202 is mechanically coupled to the second vehicle 204 by a tow hitch 206. The second vehicle 204 is towed by the first vehicle 202 in a flat tow arrangement, with the wheels of the second vehicle on the road and rotating during the flat tow. A trailer pigtail 208 can be used to provide a communication path between the first vehicle 202 and the second vehicle 204. In another embodiment, a communication path can be provided through a connection in the tow hitch 206. In another embodiment, the communication path can be a wireless communication path.

The first vehicle 202 includes a first drive system 210, a first controller 212, a first sensor system 214 and a first communication device 216. The first drive system 210 controls the transfer of torque from a first powertrain of the first vehicle 202 to the wheels of the first vehicle. The first controller 212 includes a processor for controlling operation of the first vehicle 202. The first sensor system 214 includes one or more sensors for measuring dynamic parameters of the first vehicle 202, which can include, but are not limited to, a speed of the vehicle, a motor speed, a motor torque, a yaw rate of the first vehicle, a front wheel road angle, a velocity of a wheel of the first vehicle, etc. The first sensor system 214 provides the dynamic parameters to the first controller 212. The first controller 212 can control the first communication device 216 to send a signal to the second vehicle 204. The signal can be used at the second vehicle 204 to control an operation of the second vehicle, as disclosed herein.

The second vehicle 204 includes a second drive system 220, a second controller 222, a second sensor system 224, and a second communication device 226. The second drive system 220 controls the transfer of torque from a second powertrain of the second vehicle 204 to the wheels of the second vehicle. The second controller 222 includes a processor for controlling operation of the second vehicle 204, and the second sensor system 224 can have one or more sensors for measuring dynamic parameters of the second vehicle, which can include, but are not limited to, a speed of the vehicle, a motor speed, a motor torque, a yaw rate of the second vehicle, a front wheel road angle, a velocity of a wheel of the second vehicle, etc. The second controller 222 is in communication with the second communication device 226. The second communication device 226 is configured to receive a signal from the first communication device 216 and to provide this signal to the second controller 222. The second controller 222 can perform an operation at the second vehicle 204 based on the signal.

The first controller 212 and the second controller 222 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The first controller 212 and the second controller 222 may include a non-transitory computer-readable medium that stores instructions which, when processed by one or more processors of the first controller 212 and the second controller 222, implement a method of coordinating operation of the first vehicle 202 and the second vehicle 204 during a towing operation, according to one or more embodiments detailed herein.

When the first vehicle 202 and the second vehicle 204 are mechanically hitched or mechanically coupled, the first vehicle can provide a command or instruction to the second vehicle over the communication path to control its operation. Thus, the first drive system 210 and the second drive system 220 can thus be operated as a single power entity to the serial hybrid vehicle 200. For example, the second vehicle 204 can provide positive propulsion when the first vehicle 202 is accelerating, which can aid the acceleration of the first vehicle. Additionally, the second vehicle 204 can provide a deceleration torque when the first vehicle 202 has actuated its brake system. Furthermore, the second vehicle 204 can select to operate in a regeneration mode to charge its battery pack while it is combined with the first vehicle 202 in the serial hybrid vehicle 200.

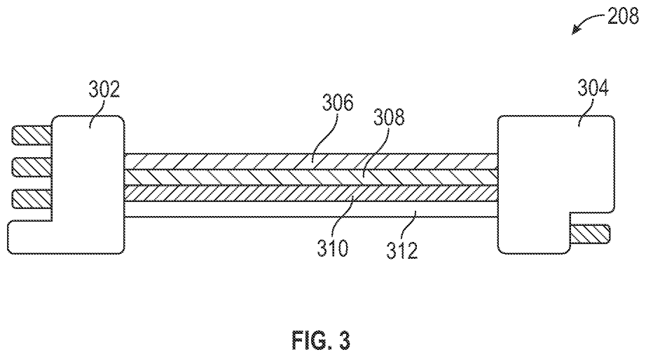

FIG. 3 shows detailed view of the trailer pigtail 208 of the serial hybrid vehicle 200, in an illustrative embodiment. The trailer pigtail 208 includes a lead vehicle coupler 302 and a follow vehicle coupler 304 with wires running therebetween. The wires include a left wheel indicator wire 306, a right wheel indicator wire 308, a taillight indicator wire 310 and a ground wire 312. A signal is sent over the left wheel indicator wire 306 when a left turn or left brake of the lead vehicle is activated. A signal is sent over the right wheel indicator wire 308 when a right turn or right brake of the lead vehicle is activated. A signal is sent over the taillight indicator wire 310 when the taillights of the lead vehicle are activated.

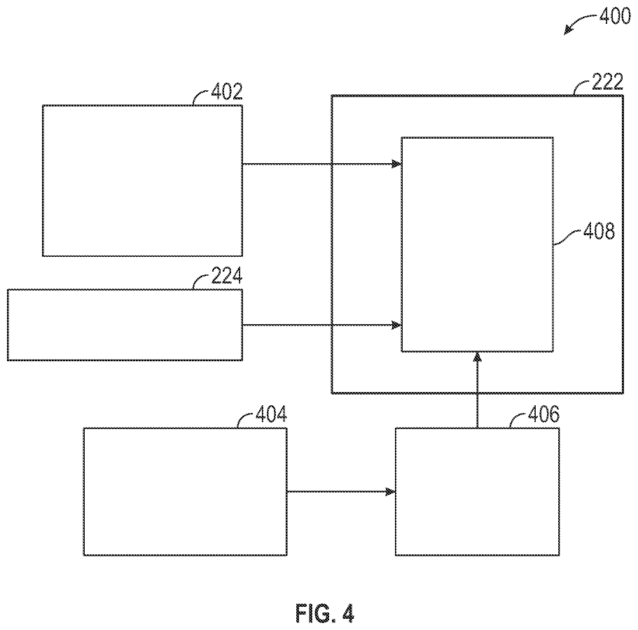

FIG. 4 is a diagram 400 illustrating data flowing to the follow vehicle during operation of the serial hybrid vehicle 200, in an illustrative embodiment. The diagram 400 shows the second controller 222 and the second sensor system 224 of the follow vehicle. The second sensor system 224 can provide status data of the follow vehicle. The diagram 400 also shows lead vehicle data 402, route data 404, and energy map data 406. The lead vehicle data 402 is provided by the first vehicle 202 and includes data such as, but not limited to, an acceleration request, a braking request, a speed of the lead vehicle, a great selection or gear state of the lead vehicle, and a brake status of the lead vehicle.

The route data 404 can be provided by a remote server and includes a route plan, weather data, elevation data, previously learned performance data. The route data 404 can be provided to energy map. The energy map locates charging stations along the route (e.g., energy map data 406) and provides these locations to the second controller 222. The second controller 222 operates at an Advanced Driver Command Interpreter module (ADCI 408). The ADCI is a program or application that controls operation of the follow vehicle during a towing scenario and which provides torque commands to the follow vehicle based on the data provided to the second controller 222.

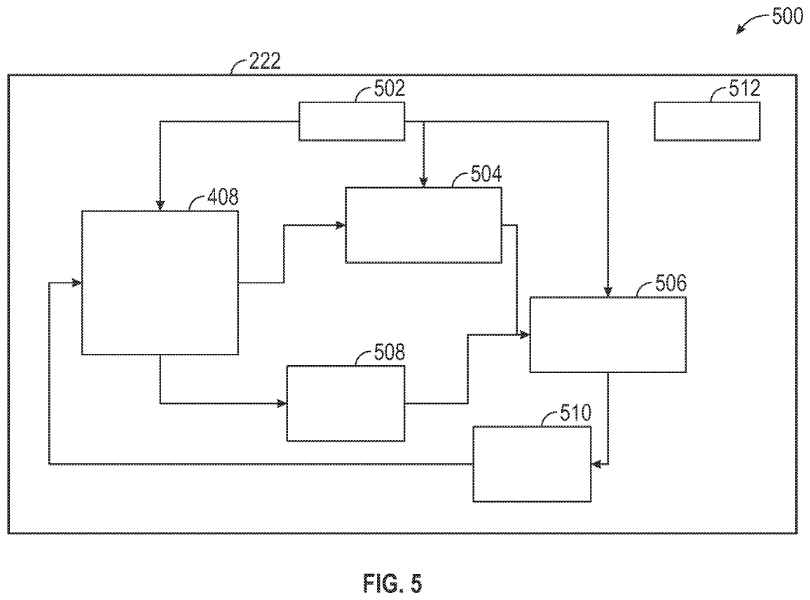

FIG. 5 is a diagram 500 showing various modules or programs operating the follow vehicle during operation of the serial hybrid vehicle 200, in an illustrative embodiment. The modules include the ADCI 408, a mode state module 502, a Driver Command Interpreter (DCI) 504, a motor controller 506, a safety limit module 508, a comparator 510, and a display 512.

The ADCI 408 receives data as shown in FIG. 4 and outputs a desired torque command to be applied at the follow vehicle. The desired torque command can be selected to optimize fuel economy and/or a range of the lead vehicle. The mode state module 502 provides a current mode of operation of the follow vehicle (such as being actively towed, driving, etc.) to the ADCI 408. The ADCI 408 outputs the desired torque command to the DCI 504 and the safety limit module 508. The DCI 504 determines a motor command for the desired torque. The safety limit module 508 maintains the applied torques within torque safety limits of the follow vehicle. The DCI 504 provides the motor command to the motor controller 506 which applies the motor commands to the motor. The comparator 510 compares the desired torque to the applied torque, there difference being provided as feedback to the ADCI 408.

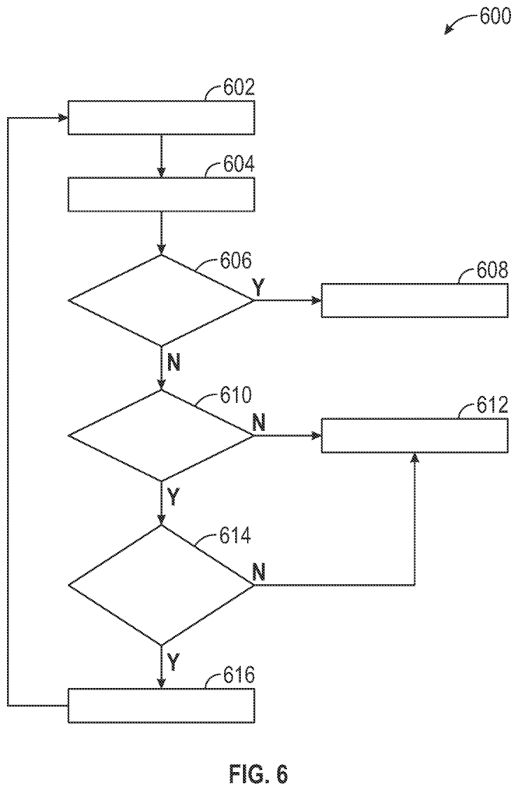

FIG. 6 shows a flowchart 600 of a method for operating the serial hybrid vehicle 200, in an illustrative embodiment. At box 602, the user plugs in the trailer pigtail 208 between the first vehicle 202 and the second vehicle 204 and initializes the application operating at the ADCI 408.

The application can prompt for a profile of the lead vehicle. The profile can be a stored profile if the lead vehicle is recognized. Otherwise, a new profile can be created. After the profile has been set up, the follow vehicle establishes a communication link to the lead vehicle (e.g., via trailer pigtail 208). The follow vehicle then prompts a user for an appropriate towing mode. Different towing modes give the user flexibility in how to charge its battery while being towed.

In box 604, the wheels of the second vehicle are unlocked (i.e., its steering lock and parking brake) to allow for freewheeling. The second vehicle 204 then flashes its headlights (or provides an audible tone) to indicate to the lead vehicle that the follow vehicle is ready for towing. The second vehicle 204 can display a message at a display to confirm the selected mode. The display can be a heads-up display (HUD).

In box 606, a brake signal of the first vehicle is queried at the second vehicle 204. The brake signal is transmitted when the first vehicle 202 applies its brakes. If the brake signal is detected (i.e., a signal along one or more of the left wheel indicator wire 306 and the a right wheel indicator wire 308), the method proceeds to box 608. In box 608, the second vehicle 204 enters a brake mode in which brake logic is applied. In one embodiment, wheel speed sensors can measure a wheel rotational speed, which can be used to select between a regeneration mode and a motor braking mode. In an embodiment, regeneration braking is applied unless the state of charge (SOC) of the battery pack is greater than a commanded SOC.

Returning to box 606, if no brake signal is detected from the first vehicle 202, the method proceeds to box 610. In box 610, a taillight signal of the lead vehicle is queried to ensure towing safety. The first vehicle 202 has its headlight on while it is operating as part of the serial hybrid vehicle 200. If a taillight signal is not detected, the method proceeds to box 612. No taillight signal (and no brakes) indicates that the first vehicle has been disconnected. In box 612, the second vehicle 204 is placed in a freewheel state. The follow vehicle can flash its headlights in a selected pattern to signal to the driver of the lead vehicle that the follow vehicle is in the free wheel state. Returning to box 610, if a taillight signal is detected, the method proceeds to box 614. Although the freewheel decision of box 606 is discussed herein as being communicated by a headlight signal, in other embodiment, any suitable signal (wired or wireless) can be used to communication between the first vehicle 202 and the second vehicle 204 to decide on whether to enter the freewheel state at the second vehicle.

In box 614, a wheel speed of the second vehicle 204 is measured. If the wheel speed vₓ of the follow vehicle is less than a speed threshold vₜₕᵣₑₛ, (vₓ<vₜₕᵣₑₛ) the method proceeds to box 612. In this condition, the second vehicle 204 is either slowing down to reverse (vₜₕᵣₑₛ>vₓ>0) or is backing up (vₓ<0). The second vehicle 204 is therefore allowed to freewheel so as not to apply any torque during these movements. Returning to box 614, if the wheel speed is greater than or equal to the speed threshold, (vₓ>vₜₕᵣₑₛ) the method proceeds to box 616.

In box 616, the follow vehicle is placed in a hybrid mode of operation. In the hybrid operation mode, the second vehicle 204 provides power to the serial hybrid vehicle 200 under instruction from the first vehicle 202. The follow vehicle alleviates the power expended by the lead vehicle by, for example, providing propulsion under its own power and providing braking, etc. Additionally, the follow vehicle can select a charge mode for charging its battery pack base on movement provided while being towed. The charging mode can be, for example, a rapid charging mode, a hybrid charging mode, a hybrid max mode, and a standard charging mode.

The rapid charging mode allows the second vehicle 204 to be charged as rapidly as possible. The mode includes charging using regeneration until the vehicle is fully charged. The charge rate for the battery is related to the speed of the vehicle.

The hybrid charging mode includes maintaining a state of charge (SOC) of the battery pack of the second vehicle at a target minimum level. If the SOC is less than the target minimum level, the second vehicle 204 is operated in a regeneration mode. Otherwise, torque is applied at the second vehicle 204 in a torque feedforward mode.

The hybrid max mode prioritizes providing propulsion at the second vehicle 204 until the SOC of the battery pack falls to a target minimum level. The hybrid max mode is the same as the hybrid charging mode except that the target minimum level is lower and the torque feedforward mode include a higher torque application set point.

The standard mode includes operating in a regeneration mode only when conditions allow, such as when braking is being applied at the second vehicle 204.

When the follow vehicle is ready to be unhitched, the user turns off the application, unhooks the tow hitch, and disconnects the trailer pigtail 208.

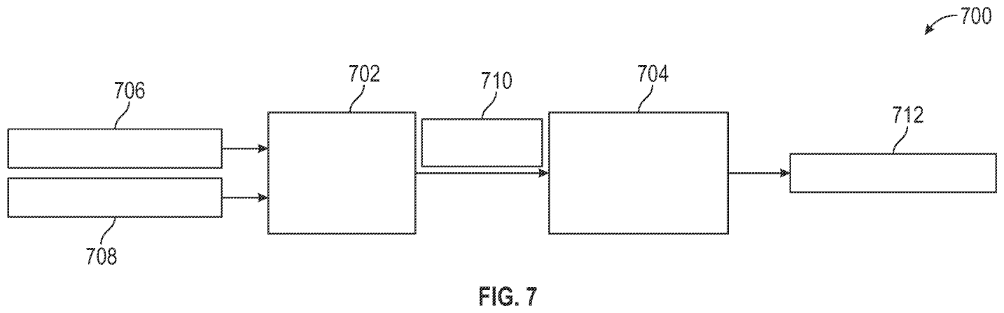

FIG. 7 shows a block diagram 700 illustrating operation of the rapid charging mode. The block diagram 700 includes a lookup table 702 and a stability controller 704. Vehicle velocity 706 and battery SOC 708 are input to the lookup table 702 in order to output a desired regeneration power 710, or an available regeneration power. The regeneration operation includes ramping up to a maximum regeneration power based on the speed of the follow vehicle. The maximum regeneration rate is capped based on the SOC of the battery pack. The desired regeneration power 710 is used to determine a desired regeneration torque 712. In one embodiment, the stability controller 704 can be used to determine the desired regeneration torque 712 from the desired regeneration power 710.

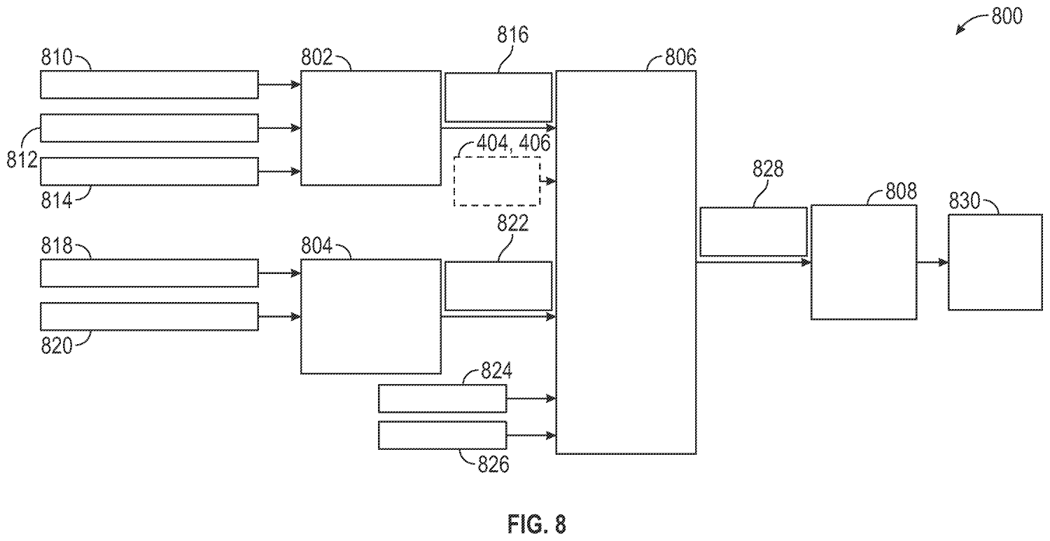

FIG. 8 is a block diagram 800 illustrating operation of a feedforward algorithm for determining a desired regeneration torque at the second vehicle 204, in an illustrative embodiment. The feedforward algorithm includes a tow angle sensor fusion module 802, a vehicle drag estimation module 804, a hybrid torque lookup table 806 and a towing stability controller 808.

A vehicle yaw rate 810, front road wheel angle 812 and wheel velocities 814 of the second vehicle 204 are input to the tow angle sensor fusion module 802, which outputs a vehicle tow angle 816. The vehicle tow angle is an angle between the first vehicle 202 and the second vehicle 204. The determination of tow angle can include a rough measurement obtained from the first vehicle 202. In another embodiment, a front camera of the second vehicle 204 can be used to determine the tow angle. The tow angle can be used to limit torque for safety purposes. For example, the higher the tow angle, the lower the maximum positive torque that can be applied by the second vehicle 204 to the first vehicle 202.

A vehicle roll and pitch 818 and a vehicle body velocity 820 are input to the vehicle drag estimation module 804, which outputs an estimated vehicle drag 822 of the second vehicle. The vehicle drag is useful for estimating a sum of longitudinal forces acting on the second vehicle, including drag, rolling resistance, road grade, etc. The drag can be calculated using an online machine learning system, a calibrated lookup table, or other methods.

The vehicle tow angle 816, the estimated vehicle drag 822, an SOC 824 of the battery and the current hybrid mode 826 of the vehicle are input to the hybrid torque lookup table 806, which outputs a regeneration torque 828. The regeneration torque 828 can be optionally modified by the towing stability controller 808 to determine a desired regeneration torque 830, when additional towing stability is needed.

The energy map data 406 and/or route data 404 can be provided to the hybrid torque lookup table 806. A decision regarding regeneration torque 828 can be based on the vehicle conditions (e.g., vehicle tow angle 816, estimated vehicle drag 822) as well as the energy map data 406 and/or route data 404 to provide locations for which peak regeneration efficiency is need and/or at which peak load conditions that will require a given percent of free SOC for propulsion purposes.

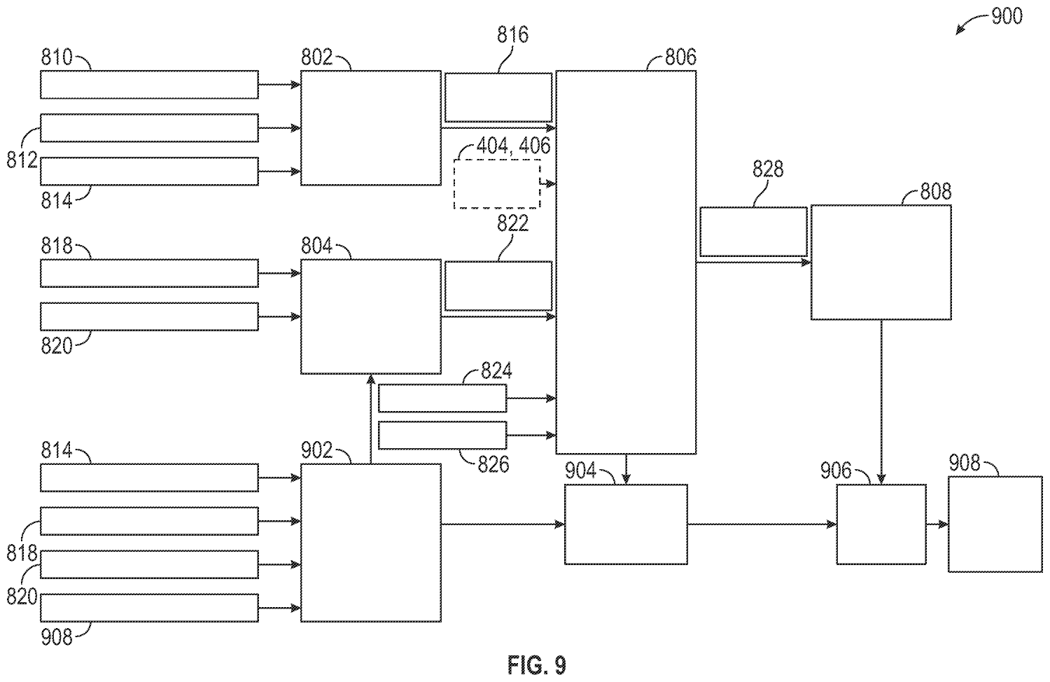

FIG. 9 is a block diagram 900 illustrating operation of a feedforward operation algorithm at the second vehicle in an alternative embodiment in which a force applied by the second vehicle 204 to the first vehicle 202 is not directly measurable. The block diagram 900 includes the tow angle sensor fusion module 802, the vehicle drag estimation module 804, the hybrid torque lookup table 806 and the towing stability controller 808 of FIG. 8. The block diagram 900 also includes a hitch force estimation module 902, a desired hitch force calculator 904 and a torque arbitrator 906.

The hitch force estimation module 902 receives, as input, wheel velocities 814 of the second vehicle 204, the vehicle roll and pitch 818 and the vehicle body velocity 820, as well as a motor torque 908 of the second vehicle 204. The hitch force estimation module 902 calculates a hitch force between the first vehicle 202 and the second vehicle 204 and provides this to the vehicle drag estimation module 804, which uses the hitch force in calculating the estimated vehicle drag 822. The hybrid torque lookup table 806 provides the commanded torque to the desired hitch force calculator 904. The desired hitch force calculator 904 calculates a torque regeneration command from the hitch force (from the hitch force estimator) and the commanded torque suitable for obtaining a desired hitch force. For example, a compressive hitch force between the first vehicle 202 and the second vehicle 204 is undesirable as it leads to instability. The torque regeneration command from the desired hitch force calculator and the command torque regeneration command from the towing stability controller 808 are input to a torque arbitrator 906, which outputs a motor torque regeneration command 908.

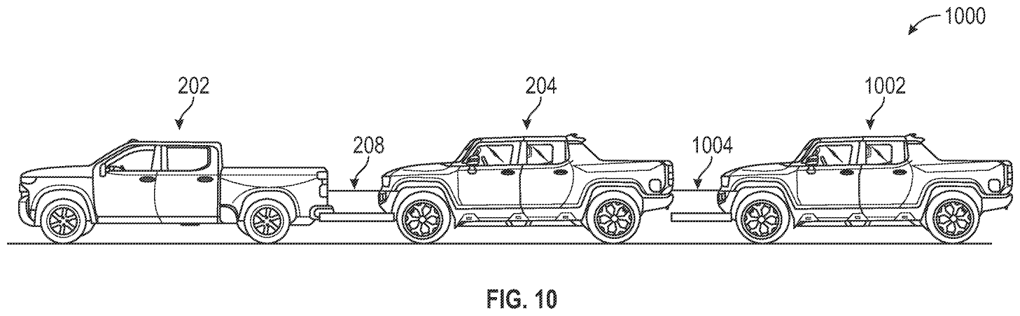

FIG. 10 shows a serial hybrid vehicle 1000 in another illustrative embodiment. The serial hybrid vehicle 1000 includes the first vehicle 202 (lead vehicle), the second vehicle 204 (first follow vehicle) and a third vehicle 1002 (second follow vehicle). The second vehicle 204 is mechanically coupled to the first vehicle 202 for towing and the third vehicle 1002 is mechanically coupled to the second vehicle 204 for towing. The second vehicle 204 and the third vehicle 1002 are electric vehicles. The trailer pigtail 208 provides a communication path between the first vehicle 202 and the second vehicle 204. A second trailer pigtail 1004 provides a communication path between the second vehicle 204 and the third vehicle 1002. The first vehicle 202 can provide commands or instructions to the second vehicle 204 and the third vehicle 1002. The third vehicle 1002 can thus be operated similarly to the second vehicle 204 during a towing operation. In another embodiment, additional electric vehicles can be attached behind the third vehicle 1002 and operated similarly.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of towing a second vehicle by a first vehicle, comprising:
establishing a communication path between the second vehicle and the first vehicle, the first vehicle having a first drive system;
transmitting a signal over the communication path from the first vehicle to the second vehicle indicative of an instruction for operating of the second vehicle; and
operating a second drive system of the second vehicle along with the first drive system of the first vehicle based on the instruction to operate the first vehicle and the second vehicle as a serial hybrid vehicle.

2. The method of claim 1, further comprising selecting a charging mode for charging a battery pack of the second vehicle.

3. The method of claim 2, wherein the charging mode is one of: (i) a rapid charging mode; (ii) a hybrid charging mode that maintains a target minimum level; (iii) a hybrid max mode that prioritizes propulsion until a state of charge of the battery pack falls to the target minimum level; and (iv) a standard charging mode that charges only when allowed.

4. The method of claim 1, further comprising at least one of: (i) applying a braking at the second vehicle when braking is applied at the first vehicle; and (ii) applying a torque at the second vehicle in response to an acceleration request from the first vehicle.

5. The method of claim 1, further comprising operating the first vehicle and the second vehicle as the serial hybrid vehicle when a speed of the second vehicle is greater than a speed threshold.

6. The method of claim 1, further comprising using data from the second vehicle to determine a velocity of the first vehicle when the velocity of the first vehicle is not available to the second vehicle.

7. The method of claim 6, further comprising determining a hitch force between the first vehicle and the second vehicle.

8. An electric vehicle, comprising:
an electric drive system;
a communication device for communicating along a communication path between the electric vehicle and a first vehicle, the first vehicle having a first drive system, the first vehicle coupled to the electric vehicle for towing the electric vehicle;
a processor configured to:
receive a signal transmitted from the first vehicle to the communication device;
determine an instruction for operating the electric vehicle from the signal; and
operate the electric drive system of the electric vehicle along with the first drive system of the first vehicle based on the instruction to operate the first vehicle and the electric vehicle as a serial hybrid vehicle.

9. The electric vehicle of claim 8, wherein the processor is further configured to select a charging mode for charging a battery pack of the electric vehicle.

10. The electric vehicle of claim 9, wherein the charging mode is one of: (i) a rapid charging mode; (ii) a hybrid charging mode that maintains a target minimum level; (iii) a hybrid max mode that prioritizes propulsion until a state of charge of the battery pack falls to the target minimum level; and (iv) a standard charging mode that charges only when allowed.

11. The electric vehicle of claim 8, wherein the processor is further configured to perform at least one of: (i) applying a braking at the electric vehicle when braking is applied at the first vehicle; and (ii) applying a torque at the electric vehicle in response to an acceleration request from the first vehicle.

12. The electric vehicle of claim 8, wherein the processor is further configured to operate the first vehicle and the electric vehicle as the serial hybrid vehicle when a speed of the electric vehicle is greater than a speed threshold.

13. The electric vehicle of claim 8, wherein the processor is further configured to use data from the electric vehicle to determine a velocity of the first vehicle when the velocity of the first vehicle is not available to the electric vehicle.

14. The electric vehicle of claim 13, wherein the processor is further configured to determine a hitch force between the first vehicle and the electric vehicle.

15. A serial hybrid vehicle, comprising:
a first vehicle having a first drive system;
a second vehicle having a second drive system;
a tow hitch for mechanically coupling the second vehicle to the first vehicle for towing by the first vehicle;
a communication path between the first vehicle and the second vehicle;
a processor at the second vehicle configured to:
receive a signal transmitted from the first vehicle to a communication device of the second vehicle via the communication path;
determine an instruction for operating the second vehicle from the signal; and
operate the second drive system along with the first drive system based on the instruction to operate the first vehicle and the second vehicle as the serial hybrid vehicle.

16. The serial hybrid vehicle of claim 15, wherein the processor is further configured to select a charging mode for charging a battery pack of the second vehicle.

17. The serial hybrid vehicle of claim 15, wherein the processor is further configured to perform at least one of: (i) applying a braking at the second vehicle when braking is applied at the first vehicle; and (ii) applying a torque at the second vehicle in response to an acceleration request from the first vehicle.

18. The serial hybrid vehicle of claim 15, wherein the processor is further configured to operate the first vehicle and the second vehicle as the serial hybrid vehicle when a speed of the second vehicle is greater than a speed threshold.

19. The serial hybrid vehicle of claim 15, wherein the processor is further configured to use data from the second vehicle to determine a velocity of the first vehicle when the velocity of the first vehicle is not available to the second vehicle.

20. The serial hybrid vehicle of claim 19, wherein the processor is further configured to determine a hitch force between the first vehicle and the second vehicle.
